(19) United States
(12) Patent Application Publication
(10) Pub. No.: US 2005/0147417 A1
(43) Pub. Date: Jul. 7, 2005

(54) Wave detection methods and apparatus

(76) Inventors: Dennis W. Prather, Landenberg, PA (US); Shrenik Deliwala, Andover, MA (US); Christopher Schuetz, Chadds Ford, PA (US)

Correspondence Address: RATNERPRESTIA, P.O. BOX 1596, WILMINGTON, DE, 19899, US

(21) Appl. No.: 10/970,519

(22) Filed: Oct. 21, 2004

Related U.S. Application Data
(60) Provisional application No. 60/512,891, filed on Oct. 21, 2003.

(51) Int. Cl. H04B 10/04

(52) U.S. Cl. 398/183

(57) ABSTRACT

Methods and apparatus for detecting waves are disclosed. The waves are detected by modulating an optical carrier signal having a carrier signal frequency component at a carrier frequency with wave signals at one or more detection frequencies, optically removing the carrier signal frequency component from the modulated optical carrier signal, and detecting an energy level of the modulated optical carrier signal after removal of the carrier signal frequency component, the energy level indicative of the presence of the wave signals.

### CROSS-REFERENCE TO RELATED APPLICATIONS

This application claims the benefit of Provisional Patent Application No. 60/512,891 filed Oct. 21, 2003, entitled “Wave Detector,” incorporated herein by reference.

### FIELD OF THE INVENTION

The present invention relates to the field of wave detection and, more particularly, to methods and apparatus for detecting waves such as millimeter-waves and microwaves.

### BACKGROUND OF THE INVENTION

Millimeter-waves and microwaves are typically detected using substantially electronic or antenna-coupled microbolometer approaches. In an electronic approach, monolithic microwave integrated circuits (MMICs) are used for filtering, amplification, and mixing at frequencies approaching 100 GHz. Systems that incorporate this technology typically cost in excess of $50K, which is cost prohibitive for many applications. Antenna-coupled microbolometers approaches, while generally less expensive, typically have noise-equivalent-powers (NEP) in the 10s of pico-watts, which does not satisfy sensitivity requirements for many applications.

There is an ever present desire for cheaper and more sensitive millimeter-wave and microwave detection methods and apparatus. Accordingly, there is a need for millimeter-wave and microwave detection methods and apparatus that are not subject to the above limitations. The present invention addresses this need among others.

### SUMMARY OF THE INVENTION

The present invention is embodied in methods and apparatus for detecting waves. The waves are detected by modulating an optical carrier signal having a carrier signal frequency component at a carrier frequency with wave signals at one or more detection frequencies, optically removing the carrier signal frequency component from the modulated optical carrier signal, and detecting an energy level of the modulated optical carrier signal after removal of the carrier signal frequency component, the energy level indicative of the presence of the wave signals.

### BRIEF DESCRIPTION OF THE DRAWINGS

The invention is best understood from the following detailed description when read in connection with the accompanying drawings, with like elements having the same reference numerals. This emphasizes that according to common practice, the various features of the drawings are not drawn to scale. On the contrary, the dimensions of the various features are arbitrarily expanded or reduced for clarity. Included in the drawings are the following figures:

FIG. 1 is a block diagram of an exemplary wave detector in accordance with an aspect of the present invention;

FIGs. 1A, 1B, 1C, and 1D are graphs depicting optical intensity versus frequency at various positions within the wave detector of FIG. 1;

FIG. 2 is a block diagram of an exemplary wave detector fabricated on a single semiconductor substrate in accordance with an aspect of the present invention;

FIG. 2A is a perspective diagram of an exemplary antenna and optical modulator in accordance with an aspect of the present invention; and

FIG. 3 is a flow chart of exemplary steps for detecting millimeter-waves and microwaves in accordance with the present invention.

### DETAILED DESCRIPTION OF THE INVENTION

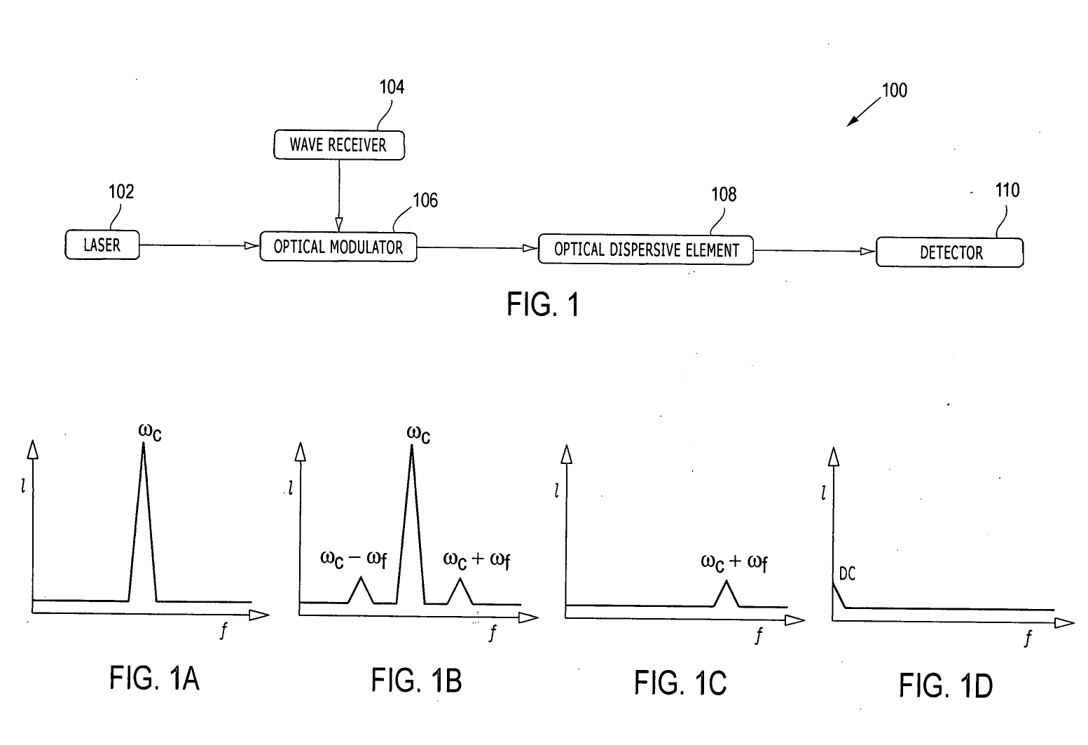

FIG. 1 depicts a block diagram of a wave detector 100 for use in providing an overview of the present invention. The wave detector 100 is described below with reference to FIGs. 1A-1D, which conceptually illustrates photon intensity (I) versus frequency (f) at various positions within the wave detector 100.

In general overview, a laser 102 generates an optical carrier signal having a carrier frequency, ω_{c}, which is illustrated in FIG. 1A. A wave receiver 104 receives one or more wave signals at one or more corresponding detection frequencies, ω_{f}, e.g., millimeter-waves and/or microwaves. A optical modulator 106 is configured to modulate the optical carrier signal with the desired wave signals, which transfers energy from the desired wave signals into sidebands of the optical carrier signal, e.g., at ω_{c}+ω_{f} and ω_{c}−ω_{f}, which is illustrated in FIG. 1B. An optical dispersive element 108 removes the carrier signal frequency component (and optionally one of the sidebands) from the modulated optical carrier signal, which is illustrated in FIG. 1C. A detector 110 then detects the remaining energy level in the modulated carrier signal after removal of the carrier frequency, which is illustrated in FIG. 1D. The remaining energy level provides an indication of the presence of waves at the one or more detection frequencies.

Modulating waves such as millimeter-waves and microwaves onto an optical carrier and optically filtering the modulated optical carrier to suppress the carrier frequency results in an easily detectable intensity level that is representative of the waves. This approach offers improved sensitivity over existing all electronic approaches that utilize complex and expensive electronic amplification, filtering, mixing techniques.

The wave detector 100 is now described in detail. The laser 102 generates a carrier signal having a carrier signal frequency component at a carrier frequency. In an exemplary embodiment, the carrier signal is an optical carrier signal (e.g., having a wavelengths of ˜200 nm-10 microns), which includes, among others, visible, infrared (IR), and ultra-violet light wavelengths. The laser 102 may be a discrete component or a semiconductor component fabricated on a semiconductor substrate such as Gallium Arsenide (GaAs).

The wave receiver 104 is configured to receive one or more wave signals at one or more corresponding detection frequencies. The wave receiver 104 may be designed to receive a specific frequency range of interest, e.g., millimeter-waves or microwaves. The wave receiver 104 may be an antenna tuned to the one or more detection frequencies or a wave guide configured to pass the one or more detection frequencies. The wave receiver 104 may be a discrete component or a semiconductor component fabricated on a semiconductor substrate such as GaAs. For example, the wave receiver 104 may be an antenna lithographically patterned on the semiconductor substrate.

The optical modulator 106 is configured to modulate the optical carrier signal with the wave signal received by the wave receiver 104. The optical modulator 106 may modulate the phase and/or amplitude of the optical carrier signal. The optical modulator 106 may be a discrete component such as a lithium niobate (LiNbO₃) electro-optic modulator or a semiconductor component fabricated on a semiconductor substrate such as GaAs.

The optical dispersive element 108 removes the carrier signal frequency component from the modulated optical carrier signal. The optical dispersive element may be a discrete component or a semiconductor component fabricated on a semiconductor substrate such as GaAs. In an exemplary embodiment, the optical dispersive element 108 is a filter configured to suppress one or more frequencies to remove the carrier signal frequency component. For example, the filter may suppress the carrier signal frequency component of the modulated optical carrier signal and, optionally, one of the side bands of the modulated optical carrier signal. If only the carrier signal frequency component is suppressed, both sidebands remain for detection. If either sideband is suppressed in addition to the carrier signal frequency component, one sideband remains for detection. Retaining both sidebands facilitates detection by delivering to the detector 110 twice the power that is available in a single side band.

In alternative exemplary embodiments, the optical dispersive element is a grating element or a photonic crystal element that separates the wave signal in at least one sideband of the optical carrier signal from the carrier signal frequency component for detection. The grating element is positioned to direct the wave signal in the at least one sideband toward the detector 110 and the carrier signal frequency component away from the detector 110 to effectively remove the carrier signal frequency component from the modulated optical carrier signal. In other exemplary embodiments, the optical dispersive element is an echelle, array waveguide grating (AWG), resonant cavity, Bragg grating, etc.

The detector 110 detects an energy level in at least one of the sidebands of the modulated optical carrier signal after removal of the carrier signal frequency component. The detector 110 may be a discrete component or a semiconductor component fabricated on a semiconductor substrate such as GaAs.

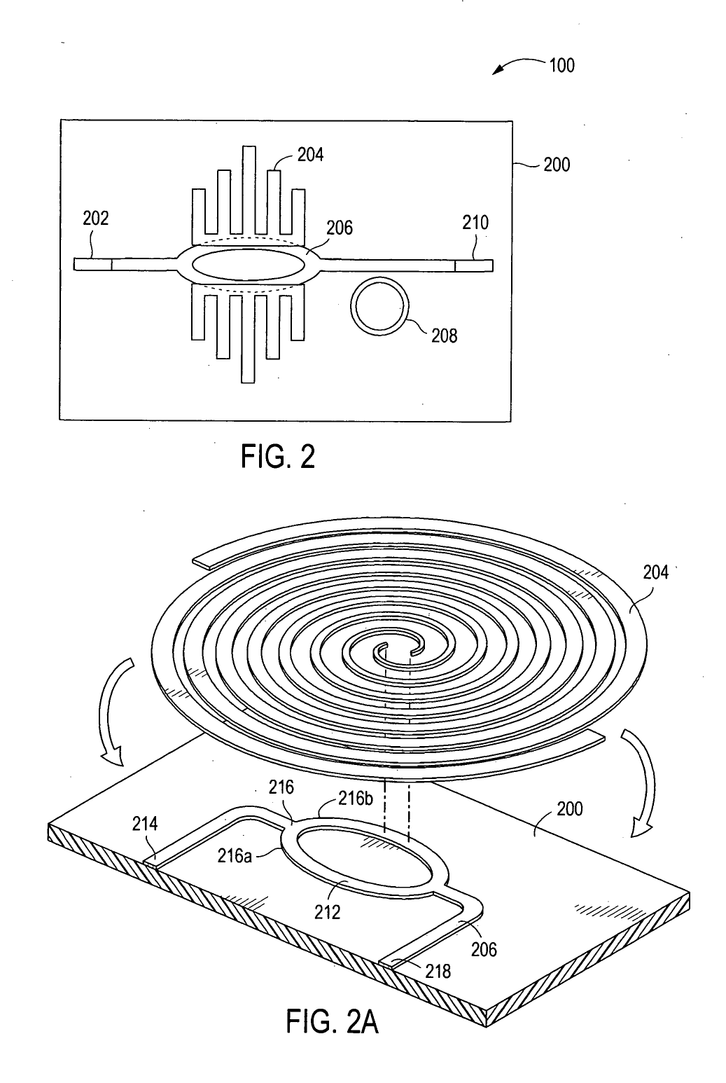

FIG. 2 depicts an exemplary wave detector 100 fabricated on a semiconductor substrate 200 such as GaAs. In the illustrated embodiment, the components of the wave detector 100 are fabricated on a common semiconductor substrate 200, e.g., a GaAs substrate. The inherent low size, weight, and power requirements of integrated optical components result in the realization of an efficient wave detector 100. In addition, fabricating the wave detector 100 in a single integrated circuit reduces sensitivity of the wave detector 100 to environmental effects such as temperature variations or vibration coupling.

A semiconductor laser 202 performs the function of the laser 102 (FIG. 1). In an exemplary embodiment, the semiconductor laser 202 is a distributed feedback (DFB) laser.

A semiconductor antenna 204 performs the function of the wave receiver 104 (FIG. 1). In an exemplary embodiment, the antenna 204 is a feed antenna, or other such guiding device, patterned directly on the substrate 200, e.g., using a lithographic pattern technique. The feed antenna should be approximately equivalent to the wavelength to be detected. Thus, for millimeter-wave signals, the total area of the device can be approximately one square millimeter or less. Thus, many such devices can be fabricated using standard semiconductor processes on a single substrate.

A semiconductor optical modulator 206 performs the function of the optical modulator 106 (FIG. 1). In an exemplary embodiment, the modulator 206 is an electro-optic modulator, e.g., a Mach-Zehnder interferometer (MZI), or an electro-absorption modulator. When the modulator 206 is excited with a desired wave frequency, ω_{f}, via the semiconductor antenna 204, power is transferred from the carrier frequency into the sidebands of the carrier signal, e.g., at frequency ω_{c}±ω_{f}.

FIG. 2A depicts a conceptual representation of the semiconductor antenna 204 and the semiconductor optical modulator 206. The semiconductor optical modulator 206 includes a waveguide 212 that is coupled to the semiconductor antenna 204. The waveguide 212 includes a first end portion 214, a center portion 216, and a second end portion 218. The center portion 216 is positioned below the semiconductor antenna 204 and includes a first branch 216a and a second branch 216b. A carrier signal entering the first end portion 214 is divided through the center portion 216 with at least part of the signal (e.g., approximately half the signal) passing though the first branch 216a and the remaining part of the signal (e.g., approximately half the signal) passing through the second branch 216b. The divided carrier signal is modulated with the wave signal received by the semiconductor antenna 204 as it passes below the semiconductor antenna 204. The waveguide 212 then combines the modulated divided carrier signal into the second end portion 218 and passes the combined modulated carrier signal from the second end portion 218 for filtering and detection. Alternatively, the modulator may consist of a phase modulator or electroabsorption modulator in which all of the signal is modulated within a single optical path on the substrate.

In an exemplary embodiment, the semiconductor antenna 204 is designed to pick up radiation in the 100 GHz band. The low frequency cut-off of the wave detector is determined by the design of the antenna and the high frequency cutoff is determined by the cut-off response of the optical modulator 206 due to the intrinsic capacitance of the optical modulator 206. In an exemplary embodiment, the optical modulator 206 is placed at the point where the antenna 204 produces a maximum radio frequency (RF) field, which is analogous to the location of an open in a transmission line. The electro-optic response of GaAs is fast and capable of THz modulation. For a 100 μm long optical modulator 206, the optical modulator 206 becomes a traveling wave structure for RF frequencies on the order of 500 GHz in GaAs. In an exemplary embodiment, the optical modulator 206 is designed such that the optical wave velocity matches the RF wave velocity.

By using a narrow waveguide structure (e.g., 100-200 nm), the response of the modulator to the applied voltage generated by the antenna can be enhanced. For example, a 1 mV voltage across a 100 nm gap produces an electric field of 10 KV/m, which is substantial in terms of inducing an electro-optic effect in a GaAs semiconductor substrate. Due to the relatively high index of refraction of GaAs, electric field flux lines are localized within the GaAs waveguide 212.

In an exemplary embodiment, the optical carrier signal is coupled in and out of the waveguide 212 using a two step approach. Initially, the optical carrier signal is processed using a high refraction index prism coupling technique and then the resultant optical carrier signal is coupled into the waveguide using integrated parabolic reflectors.

Referring back to FIG. 2, a semiconductor filter 208 performs the function of the optical dispersive element 108 (FIG. 1). In an exemplary embodiment, the semiconductor filter 208 is a ring resonator filter sized to remove the carrier frequency.

A semiconductor detector 210 performs the function of the detector 110. In an exemplary embodiment, the semiconductor detector 210 is a low bandwidth PIN detector capable of detecting photons. The energy level in the sidebands can be detected with a low-bandwidth optical detector due to the square law characteristics of optical detectors.

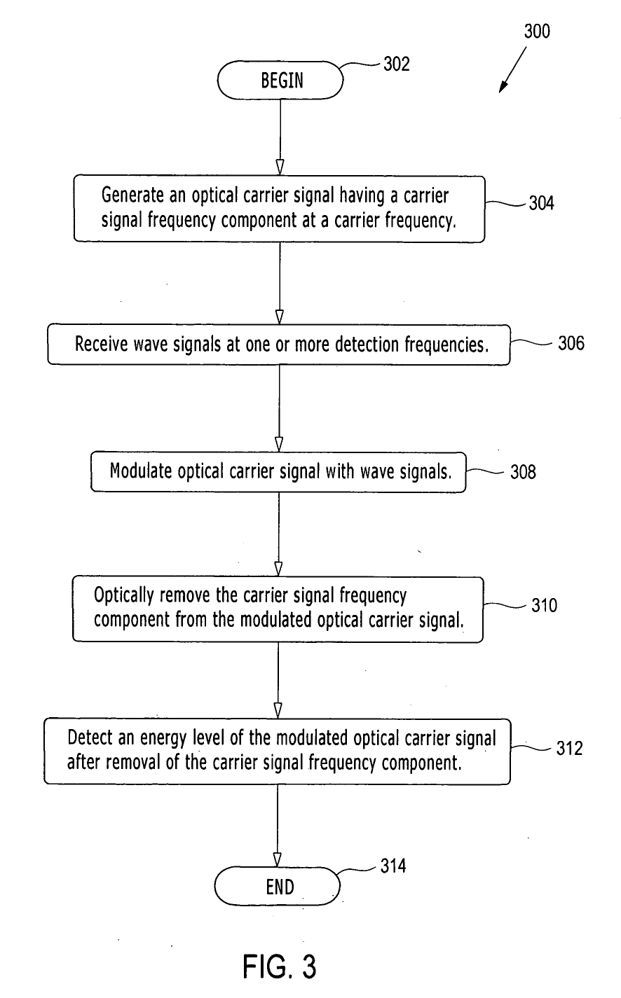

FIG. 3 depicts a flow chart 300 of exemplary steps for detecting waves such as millimeter-waves and microwaves. Processing begins at block 302 with the generation of an optical carrier signal at block 304, e.g., by a laser. The optical carrier signal has a carrier signal frequency component at a carrier frequency. At block 306, wave signals at one or more desired detection frequencies are received, e.g., via an antenna or waveguide. At block 308, the optical carrier signal is modulated with the received wave signals. At block 310, the carrier signal frequency component is removed from the modulated optical carrier signal. At block 312, the energy level of the modulated optical carrier signal with the carrier signal frequency component removed is detected. Processing ends at block 314.

A wave detector 100 (FIG. 1) in accordance with the present invention is capable of achieving noise-equivalent-powers (NEPs) on the order of 10⁻¹⁹ Watts, yielding several orders of magnitude improvement over currently available devices. Also, the wave detector 100 may be used to detect waves having frequencies between 10 GHz and 10 THz, and is especially useful for detecting waves having frequencies between 30 and 300 GHz, e.g., millimeter-waves. Thus, the bandwidths achievable using the wave detector of the present invention exceed the bandwidths of wave detectors using current monolithic-microwave-integrated-circuit (MMIC) solutions.

In addition, the wave detector 100 achieves high sensitivity through optical modulation by optimizing the electrode structure for detection at a specific frequency or frequencies of interest, utilizes optical carrier suppression properties to lower the required bandwidth of the wave detector (which, in turn, offers better detection sensitivities), and utilizes optical filtering of the modulated optical carrier signal to further reduce sources of noise outside a spectrum of interest.

Although the invention is illustrated and described herein with reference to specific embodiments, the invention is not intended to be limited to the details shown. Rather, various modifications may be made in the details within the scope and range of equivalents of the claims and without departing from the invention.

1. An apparatus for detecting wave signals comprising:
a laser that generates an optical carrier signal having a carrier signal frequency component at a carrier frequency;
a wave receiver configured to receive wave signals at one or more corresponding detection frequencies;
an optical modulator configured to modulate the optical carrier signal with the wave signals received by the wave receiver;
an optical dispersive element that removes the carrier signal frequency component from the modulated optical carrier signal; and
a detector that detects an energy level of the modulated optical carrier signal after removal of the carrier signal frequency component, the energy level indicative of the presence of the wave signals.

2. The apparatus of claim 1, wherein the wave receiver is an antenna tuned to the one or more detection frequencies.

3. The apparatus of claim 1, wherein the wave receiver is a wave guide.

4. The apparatus of claim 1, wherein the optical dispersive element is a ring resonator filter.

5. The apparatus of claim 1, wherein the optical dispersive element is a grating element that separates the wave signals from the carrier signal frequency component of the optical carrier signal for detection by the detector.

6. The apparatus of claim 1, wherein the optical dispersive element is a photonic crystal element that separates the wave signals from the carrier signal frequency component of the optical carrier signal for detection by the detector.

7. The apparatus of claim 1, wherein the laser, optical modulator, optical dispersive element, and detector are fabricated on a single semiconductor substrate.

8. The apparatus of claim 7, wherein the semiconductor substrate is Gallium Arsenide (GaAs).

9. A method for detecting wave signals, the method comprising the steps of:
modulating an optical carrier signal having a carrier signal frequency component at a carrier frequency with wave signals at one or more detection frequencies;
optically removing the carrier signal frequency component from the modulated optical carrier signal; and
detecting an energy level of the modulated optical carrier signal after removal of the carrier signal frequency component, the energy level indicative of the presence of the wave signals.

10. The method of claim 9, further comprising the step of:
receiving the wave signals at the one or more detection frequencies.

11. The method of claim 10, further comprising the step of:
tuning an antenna to receive the wave signals at the one or more detection frequencies.

12. The method of claim 9, wherein the optically removing step comprises the step of:
filtering the modulated carrier signal to suppress the carrier signal frequency component.

13. The method of claim 9, wherein the optically removing step comprises the steps of:
directing the wave signals toward a detector; and
directing the carrier signal frequency component away from the detector.

14. A system for detecting wave signals, the system comprising:
means for modulating an optical carrier signal having a carrier signal frequency component at a carrier frequency with wave signals at one or more detection frequencies;
optically removing the carrier signal frequency component from the modulated optical carrier signal; and
detecting an energy level of the modulated optical carrier signal after removal of the carrier signal frequency component, the energy level indicative of the presence of the wave signals.

15. The system of claim 14, further comprising:
means for receiving the wave signals at the one or more detection frequencies.

16. The system of claim 15, further comprising:
means for tuning the wave signals at the one or more detection frequencies.

17. The system of claim 14, wherein the means for optically removing comprises:
means for filtering the modulated carrier signal to suppress the carrier signal frequency component.

18. The system of claim 14, wherein the means for optically removing comprises:
means for directing the wave signals toward a detector; and
means for directing the carrier signal frequency component away from the detector.
